(19) United States
(12) Patent Application Publication
(10) Pub. No.: US 2011/0119232 A1
(43) Pub. Date: May 19, 2011

(54) SYNCHRONIZING DATA BETWEEN A CLIENT AND A SERVER

(75) Inventors: Adam D. Mielke, Fort Wayne, IN (US); John D. Dinh, Fort Wayne, IN (US); David A. Kiraly, Fort Wayne, IN (US); Benjamin C. Scarborough, Fort Wayne, IN (US)

(73) Assignee: Raytheon Company, Waltham, MA (US)

(21) Appl. No.: 12/620,696

(22) Filed: Nov. 18, 2009

(51) Int. Cl. G06F 17/00; G06F 12/00; G06F 15/16

(52) U.S. Cl. 707/623; 709/203; 707/E17.032; 711/E12.001

(57) ABSTRACT

In one aspect, a method to synchronize data between a client and a server, includes determining filters to limit data sent during synchronization, determining unique identifiers of data stored at a client, sending a request for synchronization including the filters and the unique identifiers to the server, retrieving data based on the filters and the unique identifiers and sending the retrieved data to the client.

### BACKGROUND

Typically, a client receives data by connecting to a server and exchanging information. In some examples, the connection between the client and server is made using a local area network that is hardwired. In other examples, the client and the server are connected wirelessly. As long as there is a connection between a server and the client, the client is able to synchronize with the server.

### SUMMARY

In one aspect, a method to synchronize data between a client and a server, includes determining filters to limit data sent during synchronization, determining unique identifiers of data stored at a client, sending a request for synchronization including the filters and the unique identifiers to the server, retrieving data based on the filters and the unique identifiers and sending the retrieved data to the client.

In another aspect, an apparatus to synchronize data between a client and a server includes circuitry to determine filters to limit data sent during synchronization, determine unique identifiers of data stored at a client, send a request for synchronization including the filters and the unique identifiers to the server, retrieve data based on the filters and the unique identifiers and send the retrieved data to the client.

In a further aspect, an article includes a machine-readable medium that stores executable instructions to synchronize data between a client and a server. The instructions cause a machine to determine filters to limit data sent during synchronization, determine unique identifiers of data stored at a client, send a request for synchronization including the filters and the unique identifiers to the server, compress the request prior to sending the request to the server, retrieve data based on the filters and the unique identifiers and send the retrieved data to the client.

### DESCRIPTION OF THE DRAWINGS

FIG. 1 is an example of a client server environment.

FIG. 2 is an example of a flowchart to synchronize data.

FIG. 3 is an example of a computer for which the process of FIG. 2 may be implemented.

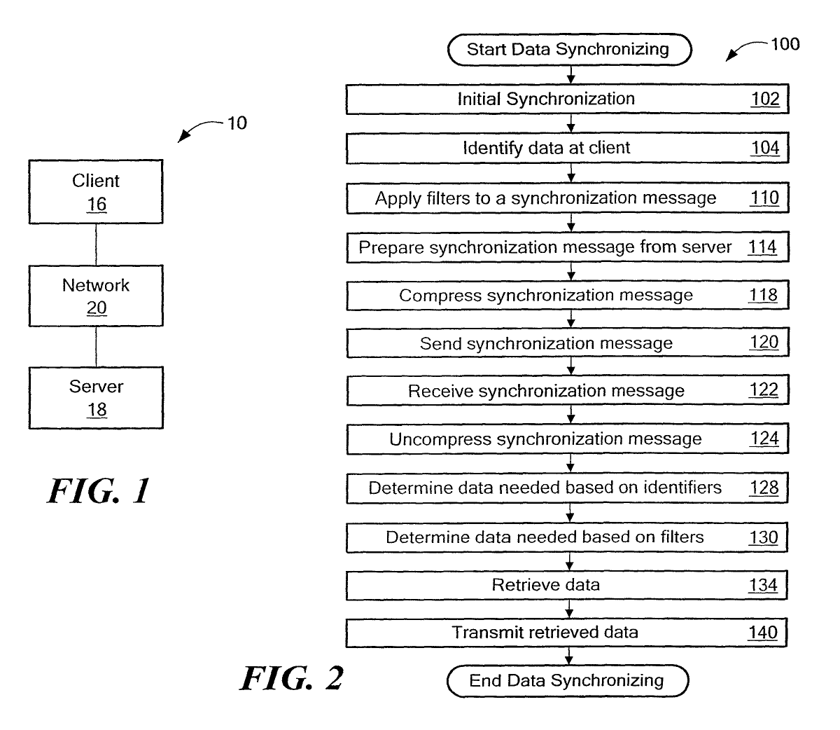

### DETAILED DESCRIPTION

Described herein are techniques to provide data synchronization between a client and a server. In particular, synchronization may be provided in limited environments. For example, a limited environment may include partial or intermittent connectivity between the client and the server. In another example, a limited environment may include a connection between the client and the server that has a low bandwidth. As will be shown, the techniques described herein allow the client to efficiently receive updated data from the server in a limited environment.

In an example of a client-server environment 10, a client 16 is connected to a server 18 through a network 20. In one example the network 20 is a wireless network and the client 16 is disposed with a mobile unit, for example, in an airplane, in a car or on a person. In this example, it is difficult for the client 16 to connect to or stay connected with the network 20. For example, there is limited bandwidth between the client 16 and the network 18 or the connection between the client 16 and the network 20 is intermittent because of obstructions or a range of the network 20, for example. In some instances, the client 16 has limited computing resources. Given these constraints it is important to have the most efficient flow of data between the client 16 and the server 18 when there is a connection.

Referring to FIG. 2, one example of a process to perform data synchronization in a limited environment between the client 16 and the server 18 is a process 100. An initial synchronization is performed between the client 16 and the server 18 (102). For example, the client 16 is connected to the server in a good environment (high bandwidth, constant connectivity) prior to being deployed in a limited environment. The initial connection allows for establishing a baseline. Subsequent synchronizations will provide updated or new data. In one example, the updates represent the deltas or the difference between data on the server 18 and data on the client 16.

The client 16 identifies data stored at the client (104). For example, the client 16 includes a database of information which is persistent at the client and is used when communication is reestablished with the server 18. When the connection is reestablished (either by gaining a communications stream or by starting a new session), the client 16 queries its data and generates a unique identifier that includes, for example, a timestamp and a checksum that uniquely represents its data. In other example, the unique identifier includes a timestamp and a hash sum. In one particular example, the data is identified in JAVA® using Fact IDs using CRC 32 checksums.

The client 16 applies filters to reduce the size of a synchronization message (110). For example, one of the filters may include one or more of a geodetic filter, a temporal filter and a contextual filter. The geodetic filter allows the client to limit data load based on an area of interest. The temporal filter reduces the message size of the synchronization message by requesting data from a specific time span. The contextual filter limits the synchronization message by filtering out data based on an entity type or by other characteristics of the data.

The client 16 prepares the synchronization message to be sent (114). The synchronization message includes the unique identifiers for the data and the filters. In one example, the client 16 uses web services applications to poll the communications stream between the client 16 and the server 18. In one particular example, the polling is performed using a Polling Consumer application. If the communications stream is degraded then the client 16 will use other techniques provided by the web services to ensure the data is received by the server 18. For example, reliable messaging and data compression may be used to address degraded networks.

Before the client 16 sends the synchronization message to the server 18, the synchronization message is compressed to address limited bandwidth between the client and the server (118). For example, the synchronization message is compressed using Fast Infoset (FI), a binary encoding format for XML (Extensible Markup Language) representation.

The synchronization message is sent to the server 18 (120). In one example, the message is sent using reliable messaging technologies such as WS-RM (Web Services-Reliable Messaging), for example, to ensure delivery of the synchronization message during times of intermittent connectivity between the client 16 and the server 18. In one example, if the transmission is interrupted, the operation will be completed upon next connection or subsequent connections.

The synchronization message is received by the server 18 (122) and the synchronization message is uncompressed (124). The server 18 evaluates the synchronization message and determines the data that is needed based on the identifiers (128). For example, the unique identifiers are evaluated to determine which data requires updating and to identify new data not previously identified by the client 16.

The server 18 further evaluates the synchronization message and determines the data needed based on the filters (130). The server 18 retrieves the new and updated data based on the identifiers and the filters (134) and transmits the new and updated data to the client 16 (140). In one example, the new and updated data is compressed similar to the compression of the synchronization message from the client 16 to the server 18 and sent using reliable messaging techniques.

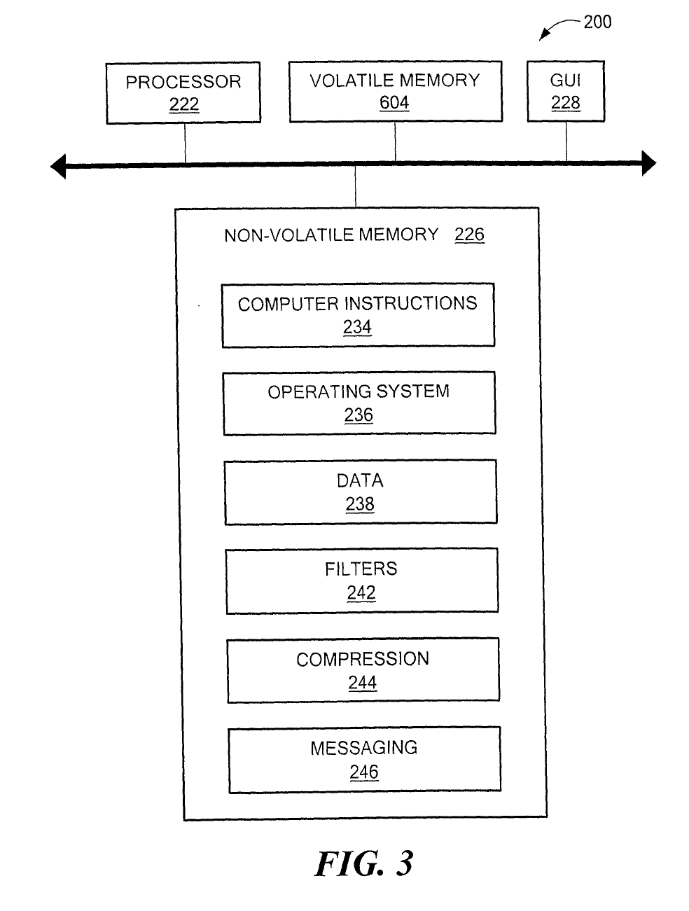

Referring to FIG. 3, an example of a computer to perform all or part of the process 100 is a computer 200. In particular, the client 16 and the server 18 may be configured like the computer 200 so that the client and the server may each may perform a respective portion of the process 100. The computer 200 includes a processor 222, a volatile memory 224, a non-volatile memory 226 (e.g., a hard disk) and a user interface (UI) 228 (e.g., a mouse, a touch screen, a keyboard, a display, and any combination thereof, for example). The non-volatile memory 226 stores computer instructions 234, an operating system 236 and data 238. The non-volatile memory 226 also stores filters 242, a compression module 244 to compress and/or encrypt messages and a messaging module 246 for sending and receiving messages. In one example, the computer instructions 232 are executed by the processor 222 out of volatile memory 224 to perform all or part of the process 100.

The processes described herein (e.g., the process 100) are not limited to use with the hardware and software configuration shown in FIG. 3; they may find applicability in any computing or processing environment and with any type of machine or set of machines that are capable of running a computer program. The processes described herein may be implemented in hardware, software, or a combination of the two. The processes described herein may be implemented as a set or subset of services in computer programs executed on programmable computers/machines that each includes a processor, a storage medium or other article of manufacture that is readable by the processor (including volatile and non-volatile memory and/or storage elements), at least one input device, one or more output devices, and a network connection. Program code may be applied to data entered using an input device to perform the processes described herein and to generate output information.

The system may be implemented, at least in part, via a computer program product, (e.g., in a machine-readable storage device), for execution by, or to control the operation of data processing apparatus (e.g., a programmable processor, a computer, or multiple computers)). Each such program may be implemented in a high level procedural or object-oriented programming language to communicate with a computer system. However, the programs may be implemented in assembly or machine language. The language may be a compiled or an interpreted language and it may be deployed in any form, including as a stand-alone program or as a module, component, subroutine, or other unit suitable for use in a computing environment. A computer program may be deployed to be executed on one computer or on multiple computers at one site or distributed across multiple sites and interconnected by a communication network. A computer program may be stored on a storage medium or device (e.g., CD-ROM, hard disk, or magnetic diskette) that is readable by a general or special purpose programmable computer for configuring and operating the computer when the storage medium or device is read by the computer to perform the processes described herein (e.g., process 100). The processes described herein may also be implemented as a machine-readable storage medium, configured with a computer program, where upon execution, instructions in the computer program cause the computer to operate in accordance with the processes.

The processes described herein are not limited to the specific embodiments described. For example, the process 100 is not limited to the specific processing order of FIG. 2. Rather, any of the processing blocks of FIG. 2 may be re-ordered, combined or removed, performed in parallel or in serial, as necessary, to achieve the results set forth above.

The processing blocks in FIG. 2 associated with implementing the system may be performed by one or more programmable processors executing one or more computer programs to perform the functions of the system. All or part of the system may be implemented as, special purpose logic circuitry (e.g., an FPGA (field programmable gate array) and/or an ASIC (application-specific integrated circuit)).

Elements of different embodiments described herein may be combined to form other embodiments not specifically set forth above. Other embodiments not specifically described herein are also within the scope of the following claims.

What is claimed is:

1. A method to synchronize data between a client and a server, comprising:
determining filters to limit data sent during synchronization;
determining unique identifiers of data stored at a client;
sending a request for synchronization including the filters and the unique identifiers to the server;
retrieving data based on the filters and the unique identifiers; and
sending the retrieved data to the client.

2. The method of claim 1, further comprising compressing the request prior to sending the request to the server.

3. The method of claim 2 wherein compress the request comprises compressing the request using Fast Infoset.

4. The method of claim 1 wherein determining unique identifiers comprises determining unique identifiers using a time stamp and a checksum.

5. The method of claim 1, further comprising performing an initial synchronization.

6. The method of claim 1 wherein sending the request for synchronization comprises sending a request for synchronization using reliable messaging.

7. The method of claim 1, further comprising determining the quality of the communications stream between the client and the server using polling.

8. The method of claim 1 wherein determining filters to limit data sent during synchronization comprises determining a geodetic filter.

9. The method of claim 1 wherein determining filters to limit data sent during synchronization comprises determining a temporal filter.

10. The method of claim 1 wherein determining filters to limit data sent during synchronization comprises determining a contextual filter using unique identifiers.

11. An apparatus to synchronize data between a client and a server, comprising:
circuitry to:
determine filters to limit data sent during synchronization;
determine unique identifiers of data stored at a client;
send a request for synchronization including the filters and the unique identifiers to the server;
retrieve data based on the filters and the unique identifiers; and
send the retrieved data to the client.

12. The apparatus of claim 11 wherein the circuitry comprises at least one of a processor, a memory, programmable logic and logic gates.

13. The apparatus of claim 11, further comprising circuitry to compress the request prior to sending the request to the server.

14. The apparatus of claim 11 wherein circuitry to determine unique identifiers comprises circuitry to determine unique identifiers using a time stamp and a checksum.

15. The apparatus of claim 11 wherein the circuitry to send a request for synchronization comprises circuitry to send a request for synchronization using reliable messaging.

16. The apparatus of claim 11 wherein the circuitry to determine filters to limit data sent during synchronization comprises circuitry to determine at least one of a geodetic filter, a temporal filter and a contextual filter.

17. An article comprising:
a machine-readable medium that stores executable instructions to synchronize data between a client and a server, the instructions causing a machine to:
determine filters to limit data sent during synchronization;
determine unique identifiers of data stored at a client;
send a request for synchronization including the filters and the unique identifiers to the server;
compress the request prior to sending the request to the server;
retrieve data based on the filters and the unique identifiers; and
send the retrieved data to the client.

18. The article of claim 17 wherein the instructions to determine unique identifiers comprises instruction to determine unique identifiers using a time stamp and a checksum.

19. The article of claim 17 wherein the instructions to send a request for synchronization comprises instructions to send a request for synchronization using reliable messaging.

20. The article of claim 17 wherein the instructions to determine filters to limit data sent during synchronization comprises instructions to determine at least one of a geodetic filter, a temporal filter and a contextual filter.
